(19) United States
(12) Patent Application Publication
(10) Pub. No.: US 2006/0267298 A1
(43) Pub. Date: Nov. 30, 2006

(54) Snowboard

(75) Inventor: Arnaud Repa, St. Egreve (FR)

Correspondence Address: BROWDY AND NEIMARK, P.L.L.C.;624 NINTH STREET, NW, SUITE 300, WASHINGTON, DC, 20001-5303, US

(73) Assignee: SKIS ROSSIGNOL, Moirans (FR)

(21) Appl. No.: 11/439,185

(22) Filed: May 24, 2006

(30) Foreign Application Priority Data
May 24, 2005 (FR) 05.51360

(51) Int. Cl. B62B 13/00

(52) U.S. Cl. 280/14.22

(57) ABSTRACT

A snowboard (1) comprising orientation-adjustable bindings each having a center (16, 17) defined as being the rotation point of their orientation adjustment mechanism, said board (1) having a length (L) defined by the distance that separates its front end point (2) and rear end point (3) projected on a horizontal plane and a width (l) defined by the distance that separates two points (7, 8) on the sidecuts (9) located on a straight line (10) at right angles to the median longitudinal axis (4) that connects said end points (2, 3) and is located halfway between said end points (2, 3), wherein the length-to-width ratio (L/1) is from 3 to 5 and wherein the distance (S) that separates the two centers (16, 17) of the bindings is from 45 to 55 cm.

### FIELD OF INVENTION

The present invention relates to the field of gliding sports on snow and, more especially, gliding boards used for snowboarding. The invention concerns, more particularly, a new board structure having optimized dimensions that allow both freestyle snowboarding and the learning of freestyle snowboarding by beginners.

The term “snowboard” is taken to mean a single board on which the user's feet are secured in a fixed position by bindings. The presence of bindings is a crucial element which makes it possible to control the board and, in particular, turn it on the gliding plane and in space, in contrast to certain gliding products that are used on road surfaces (skateboard), on water (surfboard) or on snow but which do not have bindings.

Similarly, a snowboard is a gliding implement that has a lower surface that acts as a base. This base is substantially flat apart from the camber of the board in the central area where the bindings are located. This camber can be countered by the user's weight so that the base comes into contact with the flat surface on which it rests. Thus, implements referred to as “domes” as described in Document U.S. Pat. No. 6,254,111 cannot be compared to snowboards. In fact, these implements do not have an almost flat gliding surface, on the contrary they are very convex and also have braking grooves.

### PRIOR ART

Generally speaking, the length of a snowboard is slightly less than the height of the user and is typically from 140 to 170 cm. This length is necessary in order to allow skiing in various types of snow. Thus, in order to ski in powder snow, it is necessary to have sufficient flotation and the flotation increases the longer and wider the board is. This significant length also makes it possible to benefit from an extended gliding contact surface which makes it possible to reach the high speeds which may be necessary in order to perform certain figures, especially jumps.

Nevertheless, it is obvious that this type of board is not totally appropriate for beginners who are just starting to learn. In fact, on current boards, the measured distance between one end of the board and the area where the binding is located is relatively long and is therefore equivalent to a relatively long lever arm which may, in the event of falls, cause twisting of the ankle or knee. Such falls are more frequent if the user is a beginner. It is apparent that the use of current boards is an obstacle to learning freestyle snowboarding.

Similarly, the relatively long board length which is necessary in order to achieve speed also hampers ease of handling and this also makes learning harder.

Shorter boards have already been suggested in order to enable children to snowboard.

However, this type of board is not really satisfactory because all the dimensions, i.e. length and width, are reduced proportionally. These boards are therefore not suitable for adult snowboarding because of their poor flotation. In addition, such boards are far less rigid and this is a major drawback, especially for freestyle snowboarding where boards are subjected to particularly high mechanical stresses.

The object of the invention is therefore to propose a snowboard which has gliding qualities that are satisfactory for an adult whilst nevertheless still being compatible with use by beginner who are learning freestyle snowboarding.

### SUMMARY OF THE INVENTION

The invention therefore relates to a snowboard. This board has conventional bindings the orientation of which is adjustable and each having a center defined as the rotation point of their orientation adjustment mechanism.

This board has a length L defined by the distance that separates its front end point and rear end point projected on a horizontal plane. The width l of the board is defined by the distance that separates two points on the sidecuts located on a straight line at right angles to the median longitudinal axis that connects the end points and which is located halfway between these end points.

In accordance with the invention, the length-to-width ratio of the board is from 3 to 5 inclusive. Also, the distance between the two binding centers is from 45 to 55 cm and preferably from 46 to 54 cm.

In other words, snowboards in accordance with the invention have a length-to-width ratio that is much less than that measured on existing adult boards where this ratio is generally 6 to 8. Such boards are therefore much shorter and wider overall than existing boards and this gives them excellent ease of handling without excessively reducing their flotation so that they remain perfectly suitable for adults.

It has been found that gliding feedback, in terms of edge control, acceleration, balance and control, with this type of board is substantially similar to that experienced using longer boards. One of the advantages of the present invention is that it provides this feedback at lower speed and this minimizes risks of falling and injury.

The position of the feet on the board according to the invention and, in particular, their characteristic spacing also makes it possible to achieve an extremely stable stance which favors rapid learning with optimum convenience.

Similarly, the dimensional ratio of this type of board gives it improved ease of handling compared with current boards, thereby helping to improve its suitability for learning this sport further still.

Advantageously, the length-to-width ratio must be from 3.5 to 4.95, preferably from 4 to 4.9 and ideally from 4.5 to 4.85.

In order to benefit from sufficient flotation, it is possible to select a length-to-width ratio in excess of 4.70, especially for compact boards. Thus a length-to-width ratio of 4.7 to 4.85 can also be selected.

In practice, the length-to-width ratio can be of the order of 4.8 which is equivalent, for example, to a length of 120 cm and a width of 25 cm.

Such a dimensional ratio therefore makes it possible to produce boards that are relatively short, typically shorter than 125 cm, compared with lengths of 150 cm or more for current adult boards, thereby making their use compatible with individuals classed as juniors, a category which is distinct from children and adult categories.

Advantageously and in practice, the bindings can be translationally adjustable along the median longitudinal axis of the board in order to adjust the characteristic spacing distance between the bindings which is commonly referred to as the stance.

### BRIEF DESCRIPTION OF THE DRAWINGS

In order that the way in which the invention is implemented and its resulting advantages may more readily be understood from the following description, reference is made to the accompanying single drawing which is a schematic top view of a board according to the invention.

### DESCRIPTION OF THE PREFERRED EMBODIMENTS

The snowboard (1) shown in the single drawing has a length that is defined as the distance between its front (2) and rear (3) ends.

As defined by the invention, this length L is equivalent to the projected length of the board as opposed to the developed length which would include the various curvatures of the board in the middle section and at the front and rear ends (2, 3).

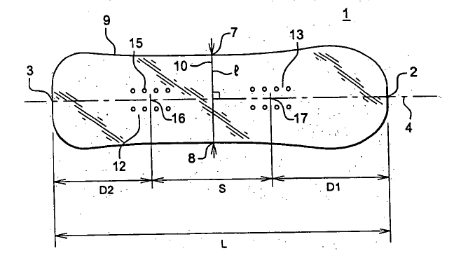

This board (1) therefore comprises a median longitudinal axis (4) which separates the board into two substantially equal parts. Note that the board shown in FIG. 1 is symmetrical either side of this longitudinal axis (4) as well as in terms of its front part and rear part. However, the invention can also be applied to shapes that may deviate from this symmetry.

According to the invention, the width l of the board is defined as the distance between the two points (7, 8) located on the sidecuts (9) of the board. These two points (7, 8) are located halfway between the end points on a straight line (10) at right angles to the median longitudinal axis (4) of the board.

In accordance with the invention, the length L of the board (1) is short in comparison with existing boards. This length L can be from 115 to 125 cm and, more especially, approximately 120 cm.

In addition, the width l of the board is, in contrast, larger than that of existing boards because it is around 25 cm compared with a width of approximately 22 cm for boards of comparable length. The length-to-width ratio is therefore roughly 4.8 for boards in accordance with the invention compared with values of 6 to 8 for existing adult boards.

The gliding board shown in the FIGURE also has areas where the bindings are mounted. These areas (12, 13) have threaded inserts (15) intended to accommodate screws for mounting a binding which are not shown. Conventionally, these bindings comprise an orientation adjustment system consisting chiefly of a disk, the first part of which is attached to the board by the mounting inserts (15) and the second part of which co-operates with the base plate.

The central position of the foot is defined by the rotation point of this rotation adjustment mechanism and corresponds substantially to points (16, 17) located on the centers of the various inserts (115) for mounting the bindings.

According to the invention, the distance separating the mounting centers (16, 17), also referred to as the stance, is adjustable thanks to their discs equipped with oblong holes, especially in the so-called “4×4” format and also the presence of several series of inserts, especially 12 inserts for the “4×4” format.

This stance distance S can vary from 46 to 54 cm.

In this way, the distance D1 that separates the front end point (2) from the point (17) located in the middle of the front binding is between 33 and 37 cm. In addition, the distance D2 that separates the rear end point (3) of the board from point (16) located in the middle of the rear binding is between 31 and 35 cm.

Such a board has a structure that is similar to that of larger snowboards. In particular, it has a similar thickness which is therefore not in proportion to its reduced length. It follows that such a board has satisfactory rigidity which is much greater than that of short snowboards used for snowboarding by short, light individuals, especially children. Thanks to this combination of features, such a board has several advantages, especially the fact that it is easier to position the center of gravity relative to the center of the board and this makes it possible to learn how to balance relatively easily and to make rapid progress.

Such a board is also less bulky and lighter than classic boards and this makes it easier to learn freestyle snowboarding. It has relatively little inertia which is good for practicing jumps. In particular, this makes it easier to grasp the nose or tail because the nose or tail are closer to the feet than they are on relatively long boards.

Such a board is also particularly easy to handle and this makes it possible to simplify learning the figures deemed to be tricky to perform using conventional long boards.

Another additional advantage is the fact that this relatively compact board is suitable for various types of users, adults or children.

1. Snowboard (1) comprising orientation-adjustable bindings each having a center (16, 17) defined as the rotation point of their orientation adjustment mechanism, said board (1) having a length (L) defined by the distance that separates its front end point (2) and rear end point (3) projected on a horizontal plane and a width (l) defined by the distance that separates two points (7, 8) on the sidecuts (9) on a straight line (10) at right angles to the median longitudinal axis (4) that connects said end points (2, 3) and is located halfway between said end points (2, 3), wherein the length-to-width ratio (L/1) is from 3 to 5 and wherein the distance (S) that separates the two centers (16, 17) of the binding is between 45 and 55 cm.

2. A snowboard as claimed in claim 1, wherein the ratio (L/1) is between 3.5 and 4.95.

3. A snowboard as claimed in claim 1, wherein the ratio (L/1) is between 4 and 4.9.

4. A snowboard as claimed in claim 1, wherein the ratio (L/1) is between 4.5 and 4.85.

5. A snowboard as claimed in claim 1, wherein the ratio (L/1) is between 4.70 and 4.85.

6. A snowboard as claimed in claim 1, wherein the length (L) is less than 125 cm.

7. A snowboard as claimed in claim 1, wherein the bindings are translationally adjustable along the median longitudinal axis of the board.

8. A snowboard as claimed in claim 1, wherein the distance (S) that separates the two centers of the bindings is from 46 to 54 cm.
